(19) United States
(12) Patent Application Publication
(10) Pub. No.: US 2005/0228557 A1
(43) Pub. Date: Oct. 13, 2005

(54) Engine maintenance

(76) Inventor: Michael David Swan, Warwickshire (GB)

Correspondence Address: Edwin V. Merkel;Nixon Peabody LLP, Clinton Square, P.O. Box 31051, Rochester, NY, 14603-1051, US

(21) Appl. No.: 11/056,592

(22) Filed: Feb. 11, 2005

(30) Foreign Application Priority Data
Feb. 19, 2004 (GB) 0403703.2

(51) Int. Cl. B60Q 11/00

(52) U.S. Cl. 701/30; 701/115; 340/457.4

(57) ABSTRACT

A device (10,60) for monitoring the runtime of an engine is disclosed. The device comprises a sensor (30), timer means (20), and means (40) for communicating information regarding the monitored engine runtime to a user. The sensor (30) is adapted to sense vibrational movement that is characteristic of that caused by the engine when running, and the timer means (20) is operably linked to the sensor (30) such that the duration of such vibrational movement, and hence engine runtime, is monitored.

This invention relates to engine maintenance, and in particular to devices for monitoring engine runtime.

Engines, and machines that incorporate engines, generally require regular maintenance and servicing in order to continue working effectively. For example, machines for use when gardening, such as lawn mowers, rotavators and scrub cutters, are typically powered by small single-cylinder petrol engines that are particularly liable to fail and therefore need to be serviced regularly. However, many such machines lack any means for monitoring the runtime of the engine and therefore facilitating adherence to a schedule of regular maintenance and servicing.

In addition, fuel consumption and emission levels are generally reduced, and the lifetime of the engine is generally extended, by regularly servicing an engine. Regular maintenance and servicing therefore has economic benefits, due to the reduced likelihood of engine failure and extended engine lifetime, and also environmental benefits, due to the reduced fuel consumption and emission levels. For example, regularly servicing a petrol engine of a lawn mower may reduce its fuel consumption by up to 30%, and reduce its emissions by up to 50%. It is conventional, therefore, for the manufacturer of a gardening machine to issue a maintenance schedule, which is usually defined in terms of hours of engine runtime from new.

In general, therefore, it is the responsibility of the user of a gardening machine, or another person such as the user's employer, to maintain an accurate record of engine runtime and thereby ensure that any necessary maintenance and servicing is carried out according to the schedule provided by the manufacturer of that machine. Clearly, maintaining an accurate record of engine runtime is inconvenient and time-consuming for the person responsible. In order to save time, a user may instead simply service the engine once each year, for example, regardless of the total engine runtime since the last service. In the case of gardening machines for home use, such as petrol-driven lawn mowers, a high percentage of owners fail to perform any form of regular maintenance to the engine. Clearly, therefore, many gardening machines may be inadequately maintained.

Devices have recently been developed that monitor the engine runtime of single cylinder engines in an attempt to address the problems set out above. However, no device has yet been developed that is entirely satisfactory. In particular, conventional devices are generally relatively awkward to fit to existing machines.

There has now been devised a device which overcomes or substantially mitigates the above-mentioned and/or other disadvantages associated with the prior art.

According to a first aspect of the invention, there is provided a device for monitoring the runtime of an engine, which device comprises a sensor adapted to sense vibrational movement that is characteristic of that caused by the engine when running, timer means operably linked to the sensor such that the duration of such vibrational movement, and hence engine runtime, is monitored, and means for communicating information regarding the monitored engine runtime to a user.

The device according to the invention is advantageous principally because the engine runtime information that is communicated to the user facilitates, and also encourages, adherence to a maintenance schedule for that engine. The device may therefore be used with a machine that incorporates an engine to ensure that both the engine and machine are properly maintained. In addition, the particular nature of the sensor allows the device to be easily fitted to any existing machine or engine. In particular, the device may be fitted to a part of the machine that is remote from the engine, but from where the sensor is still able to sense vibrational movement caused by the engine when running.

The device according to the invention is particularly suitable for use with machines that are powered by small petrol engines, for example single-cylinder petrol engines. For example, the device according to the invention may be used with gardening machines, such as lawn mowers, rotavators and scrub cutters. However, since the device according to the invention only requires the engine to cause sufficient vibrational movement of the sensor in order to function, the device according to the invention may be used with almost any type and size of engine.

The device according to the invention may be manufactured as a separate component from the machine with which the device is to be used. In this case, the device may either be sold with the machine, and hence fitted by either the manufacturer or the dealer that sells the machine, or be sold separately from the machine and hence fitted by either the dealer or the user. Alternatively, the device according to the invention may be incorporated into the machine during manufacture. For example, the device may be incorporated into an engine cover of the machine.

Where the device according to the invention is manufactured as a separate component from the machine with which the device is to be used, the device preferably includes releasable fastenings for fastening the device to a suitable part of the machine. Preferably, the device has an external surface that is adapted to abut an external surface of the machine when fastened to that machine.

The sensor is preferably adapted to output an electrical signal to the timer means while vibrational movement is sensed that is characteristic of that caused by the engine running. The sensor may be adapted to only output an electrical signal to the timer means while vibrational movement is sensed that is characteristic of that caused by the engine running. In this case, the timer means preferably monitors all periods of the output signal. However, more preferably, the sensor senses a broader range of vibrational movement than that caused by the engine when running, and outputs a varying electrical signal depending upon the amplitude and/or frequency of the sensed vibrational movement. In this case, the timer means preferably analyses the output signal so as to only monitor those periods of the output signal that are the result of sensed vibrational movement that is characteristic of that caused by the engine when running. In particular, the timer means may only monitor those periods of the output signal having a current and/or voltage that exceeds a predetermined threshold.

The sensor may be any suitable vibration sensor but is preferably a piezoelectric vibration sensor. In general, the vibration sensor may be any device capable of generating an electrical output in response to vibration of the device. A piezoelectric vibration sensor, for instance, may comprise a piezoelectric element that is fixed at one end. Vibration of the piezoelectric element creates a mechanical stress that induces an electrical current. Suitable vibration sensors may be commercially available or may readily be assembled by those skilled in the art.

The timer means preferably monitors the total engine runtime since manufacture of the device. Where an unused device is fitted to an engine or machine that is unused since manufacture, the timer means may therefore monitor the total engine runtime since manufacture of that engine. Alternatively, the timer means may be resettable such that the timer means monitors the total engine runtime since the last reset of the timer means. In either case, however, the device may be used to ensure that maintenance is carried out at regular intervals of engine runtime, or in accordance with a maintenance schedule which may be provided by the engine manufacturer. The device preferably comprises means for displaying the total engine runtime to the user. Most preferably, such means comprises an electronic display that is operably linked to the timer means such that the total engine runtime is displayed for the user. The total engine runtime is preferably displayed in terms of standard time units, and most preferably in terms of hours. The electronic display is preferably an LCD display or the like.

In order to further facilitate, and also encourage, adherence to a maintenance schedule, the device preferably includes means for storing a maintenance schedule which comprises a series of maintenance actions, each accompanied by the total engine runtime at which the action is due. The maintenance schedule and/or the maintenance action that is next due may simply be displayed to the user alongside the total engine runtime.

Most preferably, the device includes means for comparing the total engine runtime to the maintenance schedule, and means for communicating to the user that a maintenance action is due. The means for communicating to the user that a maintenance action is due may comprise an audible or visual indicator. The device according to the invention may be adapted to only communicate to the user that a maintenance action is due, and not display the total engine runtime.

Most preferably, however, the means for displaying the total engine runtime to the user is also adapted to display indicators that communicate to the user that a maintenance action is due. Such indicators may take the form of explanatory text, or explanatory icons, for example. Most preferably, the device includes a control switch operably linked to the display means such that the indicators may be cleared when the associated maintenance action has been carried out. Indicators associated with maintenance actions that require the user to return the machine or engine to an authorised dealer, such as the requirement for a full service, are preferably only clearable by an authorised dealer.

The timer means, means for storing a maintenance schedule, and means for comparing the total engine runtime to the maintenance schedule, all preferably form part of a central processor. Most preferably, the central processor is an integrated circuit. Such a circuit may readily be designed by those skilled in the art.

The device according to the invention preferably incorporates a suitable power supply, most preferably one or more dry cell batteries. Alternatively, the device may draw power from the machine to which it is fitted.

According to a further aspect of the invention, there is provided a machine including an engine and a device according to the invention, as described above.

In another aspect, the invention provides a method of monitoring the runtime of an engine, which method comprises sensing vibrational movement that is characteristic of that caused by the engine when running, monitoring the duration of such vibrational movement, and hence engine runtime, and communicating information regarding the monitored engine runtime to a user.

The invention will now be described in greater detail, by way of illustration only, with reference to the accompanying drawings, in which

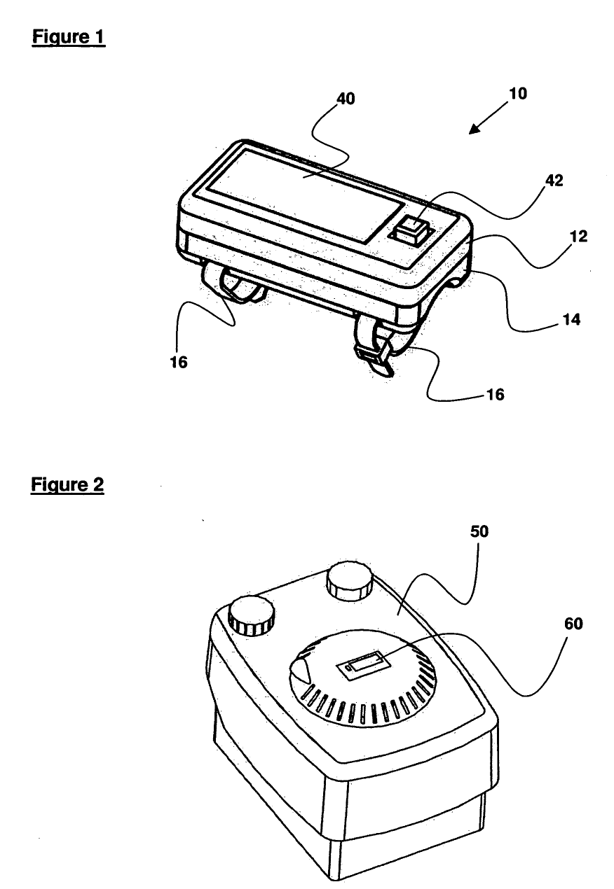

FIG. 1 is a perspective view of a first embodiment of a monitoring device according to the invention;

FIG. 2 is a perspective view of a second embodiment of a monitoring device according to the invention which is incorporated into an engine cover;

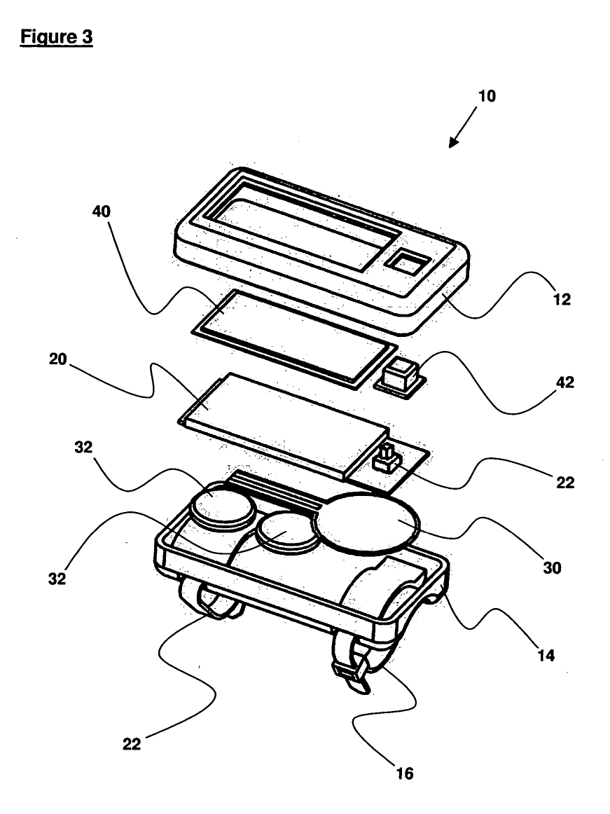

FIG. 3 is an exploded view of the device of FIG. 1; and

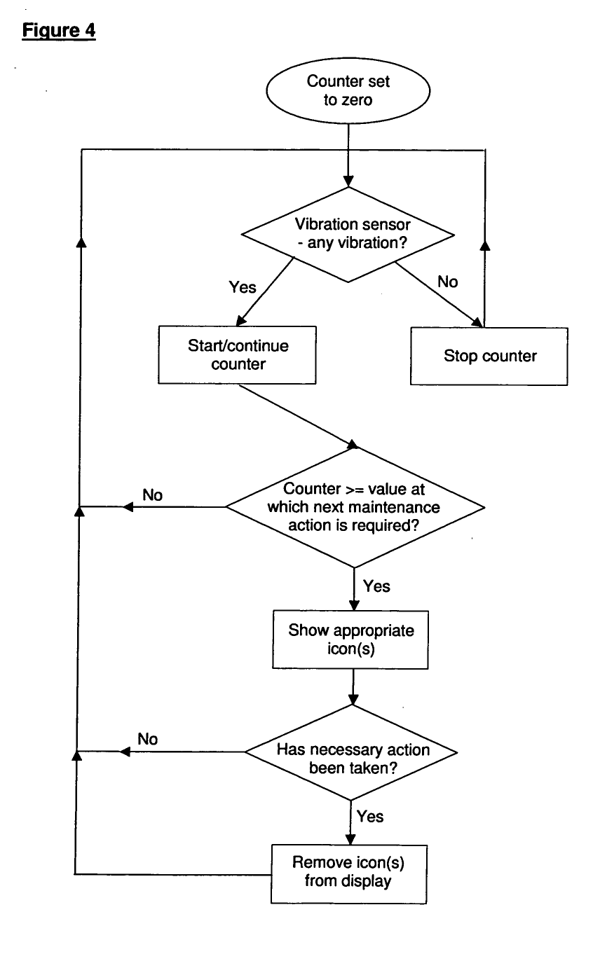

FIG. 4 is a flow diagram illustrating the logic of an integrated circuit which forms part of both the first and second embodiments of the monitoring device.

FIGS. 1 and 3 show a first embodiment of a monitoring device according to the invention, which is generally designated 10. The monitoring device 10 comprises a casing 12,14 of plastics material that encloses components of the monitoring device 10, and a pair of fastening straps 16 for fastening the monitoring device 10 to a suitable part of the machine with which the monitoring device 10 is to be used.

The casing 12,14 comprises an upper casing 12 and a lower casing 14, which are both formed by injection moulding of a suitably strong plastics material. The upper casing 12 has a generally rectangular upper wall with a large rectangular opening for accommodating a display 40, and a smaller square opening through which a control switch 22 and cover 42 project. The upper wall of the upper casing 12 also has a downwardly-projecting peripheral skirt that extends into abutment with a similarly shaped peripheral skirt of a lower wall of the lower casing 14.

The lower wall of the lower casing 14 is shaped so as to define a longitudinal channel along the underside of the monitoring device 10. The longitudinal channel defined by the lower casing 14 has a segment-shaped cross-section, and is shaped so as to abut the outer surface of a cylindrical bar, such as the handlebar of a lawnmower, of similar diameter.

Each fixing strap 16 comprises a central enlarged portion which is captivated within the casing 12,14, and a pair of narrower end portions that project from openings on either side of the lower casing 14. The narrower end portions of the fastening straps 16 are adapted to engage one another so as to secure the monitoring device 10 to a suitable part of the machine to be monitored, such as the handlebar of a lawnmower. The fastening straps 16 of the monitoring device 10 of FIGS. 1 and 3 are conventional zip-ties.

The monitoring device 10 further comprises an integrated circuit 20 and a control switch 22, which are both soldered to the upper surface of a printed circuit board (PCB), and a motion sensor 30 and a pair of batteries 32, which are both held adjacent, and are both operably linked, to the lower surface of the PCB. The batteries are pill-type batteries and are arranged so as to provide power for the integrated circuit 20 via the PCB. The control switch 22 is a push-button switch and is covered by an elastomeric button cover 42. Finally, a display 40 lies alongside, and is controlled by, the integrated circuit 20. The display 40 is an LCD display and includes a lens fixed alongside its upper surface.

The motion sensor 30 is a piezoelectric motion sensor that is able to sense vibrations having a range of different amplitudes and frequencies, including vibrations caused by use of the machine to which the monitoring device 10 is fitted. When the motion sensor 30 senses vibrations, it outputs a signal to the integrated circuit 20 according to the amplitude and/or frequency of the sensed vibrations.

During manufacture, the peripheral skirts of the upper and lower casings 12,14 are joined together so as to form a waterproof seal. The lens of the LCD display 40 is ultrasonically welded within the large rectangular aperture of the upper casing 12, and the switch 22 and cover 42 project from the smaller square opening of the upper casing 12. The casing 12,14 of the monitoring device 10 is formed so that the enclosure defined by the casing 12,14 is waterproof, thereby ensuring that the components of the monitoring device 10 are not damaged in bad weather.

The first embodiment of the monitoring device 10 is intended to be fitted using the fastening straps 16 to a handlebar, or similar part, of a lawnmower or similar machine. This may be done by a manufacturer, a dealer, or a user. In contrast, however, the second embodiment of the monitoring device 60 is incorporated, during manufacture of the lawnmower or similar machine, into an engine cover 50 of that machine, as shown in FIG. 2. In all other respects, however, the second embodiment of the monitoring device 60 is identical to the first embodiment of the monitoring device 10.

Referring now to FIG. 4, the integrated circuit 20 of the monitoring device 10,60 includes a timer that is initially set to zero. The integrated circuit 20 is also programmed with a maintenance schedule that has been devised specifically for the machine to which the monitoring device 10,60 is fitted.

The timer of the integrated circuit 20 will remain at zero until the integrated circuit 20 receives a signal from the motion sensor 30 indicating that use of the machine has commenced. The timer will then commence counting, and continue to count until the motion sensor 30 indicates that use of the machine has ceased. The timer will then stop counting. This process will be repeated each time the machine is used throughout the lifetime of the machine and/or monitoring device 10,60. The timer does not reset itself between uses so that the value of the timer corresponds to the total usage time since the machine was manufactured and/or the monitoring device was fitted to the machine. The LCD display will continually display the value of the timer converted into hours.

As illustrated by FIG. 4, the integrated circuit 20 will continually compare the value of the timer with the pre-determined values of the programmed maintenance schedule. When the value of the timer equals, or exceeds, a pre-determined value of the programmed maintenance schedule, the integrated circuit 20 will cause the LCD display 40 to display an icon. The particular icon displayed will be dependent upon the type of maintenance action required by the maintenance schedule. For example, the maintenance action required might be to check the level of oil in the engine, or to return the machine to the dealer for a full service. Once the maintenance action has been carried out, the user is generally able to clear the display 40 of icons by depressing the control switch 22 for a couple of seconds. However, where the icon displayed indicates that a full service is required, only a dealer may clear the display 40 of icons. In particular, the dealer will need to input a code using the control switch 22 to clear the display 40 of icons.

1. A device for monitoring the runtime of an engine, which device comprises a sensor adapted to sense vibrational movement that is characteristic of that caused by the engine when running, timer means operably linked to the sensor such that the duration of such vibrational movement, and hence engine runtime, is monitored, and means for communicating information regarding the monitored engine runtime to a user.

2. A device as claimed in claim 1, wherein the device is manufactured as a separate component from the machine with which the device is to be used.

3. A device as claimed in claim 1, wherein the device is incorporated into the machine during manufacture.

4. A device as claimed in claim 2, wherein the device includes releasable fastenings for fastening the device to a suitable part of the machine.

5. A device as claimed in claim 4, wherein the device has an external surface that is adapted to abut an external surface of the machine when fastened to that machine.

6. A device as claimed in claim 1, wherein the sensor is adapted to output an electrical signal to the timer means while vibrational movement is sensed that is characteristic of that caused by the engine running.

7. A device as claimed in claim 6, wherein the sensor senses a broader range of vibrational movement than that caused by the engine when running, and outputs a varying electrical signal depending upon the amplitude and/or frequency of the sensed vibrational movement.

8. A device as claimed in claim 7, wherein the timer means analyses the output signal so as to only monitor those periods of the output signal that are the result of sensed vibrational movement that is characteristic of that caused by the engine when running.

9. A device as claimed in claim 8, wherein the timer means only monitors those periods of the output signal having a current and/or voltage that exceeds a predetermined threshold.

10. A device as claimed in claim 1, wherein the sensor is a piezoelectric vibration sensor.

11. A device as claimed in claim 1, wherein the timer means monitors the total engine runtime since manufacture of the device.

12. A device as claimed in claim 1, wherein the timer means are resettable such that the timer means monitor the total engine runtime since the last reset of the timer means.

13. A device as claimed in claim 1, wherein the device comprises means for displaying the total engine runtime to the user.

14. A device as claimed in claim 13, wherein the means for displaying the total engine runtime to the user comprises an electronic display that is operably linked to the timer means such that the total engine runtime is displayed for the user.

15. A device as claimed in claim 14, wherein the electronic display is an LCD display or the like.

16. A device as claimed in claim 1, wherein the device includes means for storing a maintenance schedule which comprises a series of maintenance actions, each accompanied by the total engine runtime at which the action is due.

17. A device as claimed in claim 16, wherein the device includes means for comparing the total engine runtime to the maintenance schedule, and means for communicating to the user that a maintenance action is due.

18. A device as claimed in claim 17, wherein the means for communicating to the user that a maintenance action is due comprises an audible or visual indicator.

19. A device as claimed in claim 18, wherein the device comprises means for displaying the total engine runtime to the user that is also adapted to display indicators that communicate to the user that a maintenance action is due.

20. A device as claimed in claim 19, wherein the device includes a control switch operably linked to the display means such that the indicators may be cleared when the associated maintenance action has been carried out.

21. A device as claimed in claim 20, wherein the timer means, means for storing a maintenance schedule, and means for comparing the total engine runtime to the maintenance schedule, all form part of a central processor.

22. A machine including an engine and a device as claimed in claim 1.

23. A method of monitoring the runtime of an engine, which method comprises sensing vibrational movement that is characteristic of that caused by the engine when running, monitoring the duration of such vibrational movement, and hence engine runtime, and communicating information regarding the monitored engine runtime to a user.
